(19) United States
(12) Patent Application Publication
(10) Pub. No.: US 2005/0170224 A1
(43) Pub. Date: Aug. 4, 2005

(54) Controlled direct liquid injection vapor feed for a DMFC

(76) Inventors: Xiaoming Ren, Menands, NY (US); Juan J. Becerra, Altamont, NY (US); Robert S. Hirsch, Troy, NY (US); Shimshon Gottesfeld, Niskayuna, NY (US); Frank W. Kovacs, Waterford, NY (US); Kevin J. Shufon, Troy, NY (US)

Correspondence Address: CESARI AND MCKENNA, LLP, 88 BLACK FALCON AVENUE, BOSTON, MA, 02210, US

(21) Appl. No.: 11/023,666

(22) Filed: Dec. 28, 2004

Related U.S. Application Data
(63) Continuation-in-part of application No. 10/413,983, filed on Apr. 15, 2003.

(51) Int. Cl. H01M 8/04; H01M 8/02

(52) U.S. Cl. 429/15; 429/34; 429/38; 429/26

(57) ABSTRACT

A fuel cell system having a methanol vapor delivery component or film is provided. The component includes an evaporation pad. The evaporation pad is disposed within the fuel cell generally parallel to the anode diffusion layer, but with a vapor gap provided between the evaporation pad and the anode diffusion layer. A fuel delivery conduit having at least one injection port is provided through which liquid fuel is delivered from an associated source of highly concentrated fuel into the evaporation pad, at a controlled, adjustable rate. Multiple parallel liquid delivery points can also be provided. In order to ensure uniform delivery of fuel across the across the active area of the anode, one or more dispersion members are placed on the evaporation pad to effectively disperse the fuel laterally around each injection port.

### CROSS-REFERENCE TO RELATED APPLICATION

The present application is a continuation-in-part of commonly assigned co-pending U.S. patent application Ser. No. 10/413,983, which was filed on Apr. 15, 2003, by Ren et al., for a DIRECT OXIDATION FUEL CELL OPERATING WITH DIRECT FEED OF CONCENTRATED FUEL UNDER PASSIVE WATER MANAGEMENT, and is hereby incorporated herein by reference.

### BACKGROUND OF THE INVENTION

1. Field of the Invention

This invention relates generally to direct oxidation fuel cells, and more particularly, to fuel cells that operate with delivery of high concentration fuel and passive water management.

2. Background Information

Fuel cells are devices in which an electrochemical reaction involving a fuel molecule is used to generate electricity. A variety of compounds may be suited for use as a fuel depending upon the specific nature of the cell. Organic compounds, such as methanol or natural gas, are attractive fuel choices due to the their high specific energy.

Fuel cell systems may be divided into “reformer-based” systems (i.e., those in which the fuel is processed in some fashion to extract hydrogen from the fuel before it is introduced into the fuel cell system) or “direct oxidation” systems in which the fuel is fed directly into the cell without the need for separate internal or external processing. Many currently developed fuel cells are reformer-based systems. However, because fuel processing is complex and generally requires components which occupy significant volume, reformer based systems are presently limited to comparatively large, high power applications.

Direct oxidation fuel cell systems may be better suited for a number of applications in smaller mobile devices (e.g., mobile phones, handheld and laptop computers), as well as in some larger scale applications. In direct oxidation fuel cells of interest here, a carbonaceous liquid fuel (typically methanol or an aqueous methanol solution) is introduced to the anode face of a membrane electrode assembly (MEA).

One example of a direct oxidation fuel cell system is a direct methanol fuel cell system, or DMFC system. In a DMFC system, methanol or a mixture comprised of methanol and water is used as fuel (the “fuel mixture”), and oxygen, preferably from ambient air, is used as the oxidizing agent. The fundamental reactions are the anodic oxidation of the fuel mixture into CO₂, protons, and electrons; and the cathodic combination of protons, electrons and oxygen into water.

Typical DMFC systems include a fuel source, fluid and effluent management sub-systems, and air management sub-systems, in addition to the direct methanol fuel cell itself (“fuel cell”). The fuel cell typically consists of a housing, hardware for current collection and fuel and air distribution, and a membrane electrode assembly (“MEA”), which are all typically disposed within the housing.

The electricity generating reactions and the current collection in a direct oxidation fuel cell system take place within and on the MEA. In the fuel oxidation process at the anode, the products are protons, electrons and carbon dioxide. Protons (originating from fuel and water molecules involved in the anodic reaction) migrate through the catalyzed membrane electrolyte, which is impermeable to the electrons. The electrons travel through an external circuit, which includes the load, and are united with the protons and oxygen molecules in the cathodic reaction, thus providing electrical power from the fuel cell and water product at the cathode of the fuel cell.

A typical MEA includes a centrally disposed protonically-conductive, electronically non-conductive membrane (“PCM”, sometimes also referred to herein as “the catalyzed membrane”). One example of a commercially available PCM is Nafion® a registered trademark of E.I. Dupont de Nemours and Company, a cation exchange membrane based on polyperflourosulfonic acid, in a variety of thicknesses and equivalent weights.

The PCM is typically coated on each face with an electrocatalyst such as platinum, or platinum/ruthenium mixtures or alloy particles. On either face of the catalyst coated PCM, the electrode assembly typically includes a diffusion layer. The diffusion layer on the anode side is employed to evenly distribute the liquid fuel mixture across the catalyzed anode face of the PCM, while allowing the gaseous product of the reaction, typically carbon dioxide, to move away from the anode face of the PCM. In the case of the cathode side, a wet-proofed diffusion layer is used to allow a sufficient supply of oxygen by minimizing or eliminating the build-up of liquid, typically water, on the cathode aspect of the PCM. Each of the anode and cathode diffusion layers also assists in the collection and conduction of electric current from the catalyzed PCM.

Direct oxidation fuel cell systems for portable electronic devices should be as small as possible at the power output required. The power output is governed by the rate of the reactions that occur at the anode and the cathode of the fuel cell. More specifically, the anode process in direct methanol fuel cells based on acidic electrolytes, including polyperflourosulfonic acid and similar polymer electrolytes, involves a reaction of one molecule of methanol with one molecule of water. In this process, the oxygen atom in the water molecule is electrochemically activated to complete the oxidation of methanol to a final CO₂ product in a six-electron process, according to the following chemical equation
CH₃OH+H₂O=CO₂₊₆H⁺+6e⁻ (1)

Since water is a reactant in this anodic process at a molecular ratio of 1:1 (water:methanol), the supply of water, together with methanol, to the anode at an appropriate weight (or volume) ratio is critical for sustaining this process in the cell. In fact, it has been known that the water:methanol molecular ratio in the anode of the DMFC has to significantly exceed the stoichiometric, 1:1 ratio shown by process (1). This excess is required to guarantee complete, 6 electron anodic oxidation to CO₂, rather than partial oxidation to either formic acid, or formaldehyde, 4e⁻ and 2e⁻ processes, respectively, described by equations (2) and (3) below:
CH₃OH+H₂O=HCOOH+4H⁺+4e⁻ (2)
CH₃OH=H₂CO+2H⁺+2e⁻ (3)

Equations (2) and (3) describe partial processes that are not desirable and which might occur if anode water content is not sufficient during a steady state operation of the cell. Particularly, as is indicated in process (3), involving the partial oxidation of methanol, water is not required for this anode process and thus, this process may dominate when the water level in the anode drops below a certain point. The consequence of process (3) domination, is an effective drop in methanol energy content by 66% compared with consumption of methanol by process (1), which would result in a lower cell electric energy output. In addition, it might lead to the generation of a hazardous anode product (formaldehyde).

Typically, it has been difficult to provide in a tightly volume-limited DMFC technology platform, the high ratio water/methanol mixture at the anode catalyst that ensures effective and exclusive anode process (1). The conventional approaches to this problem can be divided into two categories:
(A) active DMFC systems, utilizing reservoirs of neat methanol and based on water collection and back pumping pumping, and
(B) passive systems requiring no water pumping, utilizing reservoirs containing methanol/water mixtures.

Class A, “active” systems that include pumping, can maintain, in principle, appropriate water content in the anode, by dosing neat methanol from a fuel delivery cartridge into an anode fluid recirculation loop. The loop typically receives water collected at the cathode and pumped back into the recirculating anode liquid. In this way, an optimized water/methanol anode mix can be maintained in a system with neat methanol in the cartridge. The concentration within the anode can be controlled using a methanol concentration sensor. The advantage of this approach is that neat methanol (100% methanol) or a very high methanol concentration solution can be carried in the cartridge.

Carrying a high concentration fuel source maximizes the energy content of the overall system. The disadvantage of Class A systems is that while neat methanol can be carried in the cartridge, the system suffers from excessive complexity due to the pumping and recirculation components which result in significant parasitic power losses and increase in system volume. Such power losses can be particularly severe, relative to fuel cell power output, in the case of small scale power sources.

The class B systems, which are passive in nature, have the advantage of system simplicity achieved by potentially eliminating pumping and recirculation by using a design that carries a mixture of water and methanol in the fuel source reservoir. This type of system can be substantially completely passive as long as the rate of water loss through the cathode is adjusted by means of materials and structures. These materials and structures operate to match the reservoir composition so as to ensure zero net rate of water loss (or water accumulation) in the cell. The problem with this approach is that it requires that the system carries a significant amount of water together with the methanol in the cartridge. Carrying a methanol/water mix in the reservoir or cartridge, of a composition well under 100% methanol, results in a significant penalty in energy density of the power pack.

A fuel cell system that adapts the best features of both the Class A and Class B, (without the disadvantages of these two known systems,) would be quite advantageous.

However, the possibility of supply of highly concentrated methanol, including 100% methanol, directly from a reservoir into the anode compartment, has not been considered practical without, at the same time, supplying water as well into the anode compartment by either collecting it from the cathode and externally pumping it back or, alternatively, directly feeding water from a reservoir of water-diluted methanol. In other words, the combination “Passive DMFC System” and “Neat Methanol Supply to the Anode” has not been considered feasible, as this has been fully expected to result in significant loss of methanol flowing across the membrane (significant methanol “cross-over”) and/or in an anode process different than (1).

In addition to providing these advantages, it would also be advantageous to allow for fuel delivery at an adjustable, controlled rate from a reservoir that is not directly adjacent to the fuel cell. More specifically, microfuel cells appear to be particularly well suited for use in hand held electronic devices such as cellular telephones, personal digital assistants, and laptop computers. However, space in such small devices is limited such that the form factors for any powering unit for use in connection with such devices is a critical design feature. It would thus be advantageous to locate the fuel cartridge or fuel reservoir in an available open volume within the fuel cell system even though the fuel cell itself may be located separately. It is thus an object of the present invention to provide such a direct oxidation fuel cell system that is capable of carrying highly concentrated fuel, including neat (100%) methanol, and providing a fuel cell system in which the fuel source can be located in a place other than side by side with the fuel cell; it is a further object to provide a direct oxidation fuel cell which can deliver fuel directly to the anode from a remotely located fuel source; it is a further object that the rate of liquid fuel delivery from the reservoir be adjustable and under control and it is as further object that the fuel cell uses passive water management techniques and simple and effective carbon dioxide removal techniques.

### SUMMARY OF THE INVENTION

The disadvantages of prior techniques are overcome by the present invention, which provides a unique, passive direct oxidation fuel cell system, which includes the following features: 1) the fuel cell system carries a high concentration fuel, including the option of neat methanol; 2) the fuel cell system limits the delivery rate of the fuel so that the fuel substance is consumed to large degree, typically 80%-90%, when it comes into contact with the anode face of the catalyzed membrane and mixes there with water provided internally from the cathode; 3) the fuel cell system of the present invention includes passive water management components for maintaining a balanced distribution of water in the cell, and 4) the fuel cell includes features and components for simple and effective carbon dioxide release from the anode chamber of the fuel cell.

In accordance with one aspect of the invention, an optimized water profile within the fuel cell is achieved by using water management elements to confine a substantial portion of the water of the fuel cell between the two diffusion layers, minimizing water loss or discharge from the fuel cell. This is accomplished using a water management component such as a hydrophobic microporous layer, or a water management film placed in intimate contact with the cathode catalyst, or with both anode and cathode catalyst layers, and applying sufficient compression to maintain effective uniform adhesion of such water management component to the catalyst layer even as liquid water builds up at the interface between the catalyst layer and said water management component, thus ensuring water back-flow from the cathode into the membrane.

In accordance with the present invention, instead of actively circulating water back into the anode, the invention described pushes liquid water back from the cathode to the anode through the cell membrane. In accordance with one aspect of the present invention, a hydrophobic microporous layer is utilized as a water management membrane that is disposed in the cathode chamber of the fuel cell between the cathode diffusion layer and the catalyzed membrane electrolyte. In this way, water that is produced in the cathode half reaction is blocked by the severe barrier to liquid water penetration presented by a microporous hydrophobic layer which consequently applies back hydrostatic pressure which pushes water from the cathode back into and through the membrane electrolyte.

The water management element may be comprised of a film of expanded PTFE (preferably impregnated with carbon microparticles to facilitate electronic conduction), or it may be a microporous layer, based on carbon microparticles impregnated with PTFE, attached to the carbon cloth or carbon paper backing material. Regardless of its construction, this layer must be gas permeable to allow oxygen to the cathode catalyst while substantially preventing liquid water from escaping. Additional conditions for effective push-back of liquid water into the membrane, are effective bonding between the catalyst and water management layer and sufficient mechanical compression across the cell applied by appropriate framing, that keeps the microporous layer, or micro-porous film, well attached to the catalyst layer even as water pressure builds up at this interface in a cell under current.

The unique features of the present invention allow this optimized water distribution in the cell to be maintained, even when neat methanol is directly supplied from the fuel cartridge (or reservoir). The present invention enables to deliver the neat fuel at the appropriate rate into the anode chamber as required to achieve an optimized, low concentration in contact with the anode face of the catalyzed membrane, to which face water is effectively supplied internally across the membrane from the cathode. As noted herein, the desirable reaction at the anode is process (1), which involves one molecule of methanol and one molecule of water, and in order for this reaction to proceed the rate of methanol supply has to be controlled such that a sufficient amount of water that is needed for process (1) to occur, flows back from the cathode into the anode chamber.

One important feature of this invention is the selection of an anodic mass-transport barrier that provides an optimized rate of fuel delivery from a reservoir of very concentrated methanol and preferably neat or near neat methanol, to the anode aspect of the membrane electrolyte.

In reduction to practice of Class A or Class B Systems, as described herein, fuel delivery rate is typically controlled by pumping or other active method. In the present invention, fuel delivery rate can be controlled passively, as set forth in commonly-assigned United States Patent Application of Ren et al., entitled FLUID MANAGEMENT COMPONENT FOR USE IN A FUEL CELL, United States Application No. 10/260,820, filed Sep. 30, 2002, and which is incorporated herein. The delivery rate can be controlled through a mass transport barrier if the proper delivery rate can be defined and the permeability of methanol through such barrier is measurable under the relevant cell operation conditions and can be set with readily available material properties, within a desired range.

In order to satisfy all of these considerations, the present invention provides a fuel transport barrier, which, in one embodiment of the invention is a methanol vapor delivery film, which is typically placed between the fuel source and the catalyzed membrane electrolyte and along the same plane as of the catalyzed membrane electrolyte. The transport barrier is in such case comprised of a thin, phase-changing “pervaporation” film that acts as a controlled fuel delivery barrier between a concentrated methanol source and anode face of the membrane electrolyte assembly. The methanol delivery film controls the rate of fuel transport across the film, as set by selecting a material, or materials for the film and the film thickness. The inventive anode transport barrier allows the use of a neat methanol feed, yet defines a controlled rate of fuel delivery to result, following mixing with the internally supplied water from the cathode, in an appropriate low concentration of methanol at the anode catalyst and, consequently, in consumption to large degree (typically 80-90%) of the delivered fuel at the cell anode. The methanol delivery film may be integrated as part of a cartridge or can be part of the fuel cell system itself, when fuel is stored internal to the system.

In accordance with another aspect of the invention, the methanol delivery film can be comprised of an evaporation pad which allows for fuel to be delivered to such pad in liquid form from a fuel reservoir that is located remotely from the fuel cell anode. A preferred mode of liquid fuel delivery to the evaporation pad, would be pumping, in which case controlled adjustment and metering of the rate of fuel delivery become possible.

Such controlled adjustment of the rate of liquid fuel delivery is an important key for achieving high fuel utilization in this mode of operation.

The evaporation pad is disposed generally parallel to the anode diffusion layer, (also referred to as an anode backing). A vapor gap is provided between the evaporation pad and the anode diffusion layer. A conduit from a fuel source has at one end thereof a flow splitter. Liquid fuel is delivered at a controlled rate from the fuel source via the conduit and the flow splitter. The flow splitter is a network of tubes that divides the flow from the single conduit into individual branching tubes, comprising injection ports. A liquid dispersion member which is particularly useful when the number of injection ports per unit anode area is limited and the anode vapor gap is narrow, can be placed over the evaporation pad, in contact with the major surface of the pad facing the anode. This liquid dispersion member may be substantially comprised of a single, or patterned baffle, made of tape or foil material impermeable to fuel in either liquid or vapor form that acts to facilitate lateral distribution of liquid fuel entering the pad through discrete injection points. Alternatively, several dispersion members can be used as described herein.

Carbon dioxide management techniques are also provided in accordance with the invention.

### BRIEF DESCRIPTION OF THE DRAWINGS

The invention description below refers to the accompanying drawings, of which:

FIG. 1 is an isometric illustration of a fully assembled direct oxidation fuel cell including a fuel reservoir constructed in accordance with one embodiment of the invention;

FIG. 2 is a simplified schematic illustration of a direct oxidation fuel cell including the water management components of the present invention;

FIG. 3 is an alternative embodiment of the fuel cell of FIG. 2, in which carbon dioxide is driven through the membrane electrolyte;

FIG. 4 is a cross-sectional view of the fuel cell system in accordance with the present invention including the methanol delivery film, and in which carbon dioxide is routed out of the anode vapor chamber;

FIG. 5 is a schematic illustration providing further details of the composition of the methanol delivery film of the fuel cell of the present invention that acts as a fuel delivery barrier between a concentrated methanol source and the anode face of the membrane electrolyte;

FIG. 6A is an exploded perspective illustration of the anode portion of one embodiment of the fuel cell system of the present invention illustrating a frame for holding the methanol delivery film and the water management layer;

FIG. 6B is an enlarged detail of the carbon dioxide router of the anode portion of the fuel cell system of FIG. 6A;

FIG. 7A is a schematic illustration of the fuel cell system based on adjustable, controlled liquid fuel delivery including the evaporation pad component;

FIG. 7B is schematic illustration of a portion of the fuel cell of FIG. 7A, depicting a flow splitter and multiple injection ports;

FIG. 8 is a cross-sectional view of the fuel cell system in accordance with the present invention in which carbon dioxide is directed out through conduits in the membrane electrolyte;

FIG. 9 is an exploded perspective illustration of the cathode portion of one embodiment of the fuel cell system of the present invention; and

FIG. 10 is an exploded overall system assembly illustration of one embodiment of the fuel cell system of the present invention.

### DETAILED DESCRIPTION OF AN ILLUSTRATIVE EMBODIMENT

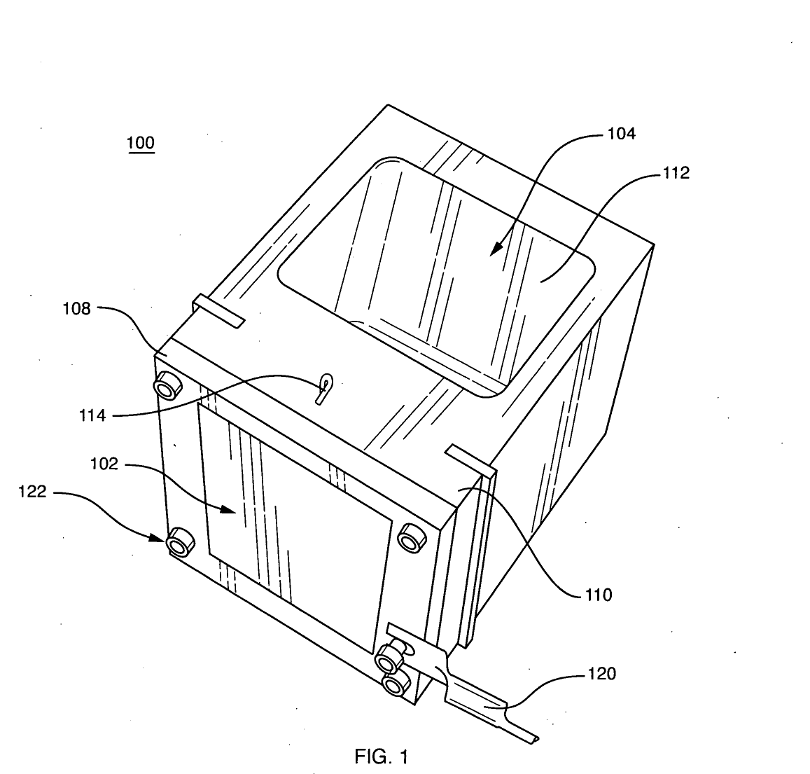

FIG. 1 illustrates a direct oxidation fuel cell system 100 that includes a direct oxidation fuel cell 102 in conjunction with a fuel reservoir 104. The fuel cell 102 is held together by a frame 108 and it is encapsulated within a plastic exterior housing 110, which may be comprised of a plastic. The fuel reservoir 104 has a recess 112 into which fuel or a fuel cartridge is inserted to begin the delivery of fuel to the anode portion of the fuel cell as will be discussed in further detail hereinafter. The anode portion of the fuel cell has no liquid outlet. In FIG. 1, the active surface of the cathode is located on the aspect corresponding to the front face of the cell as shown. The anode current collection lead 114 is in ohmic contact with the anode current collector (hidden in FIG. 1) and can be connected with the cathode current collector lead 120 to form an electrical circuit and a load can be connected across the leads 114 and 120 to utilize the electricity produced by the fuel cell. Bolts 122 provide significant compression on the frame of the cell, translated to the main surface of the membrane/electrode assembly by rigid current collectors, thereby ensuring good uniform adhesion, particularly between surfaces 244 and 208, as required for effective, passive water management.

Water Management Features and Structures

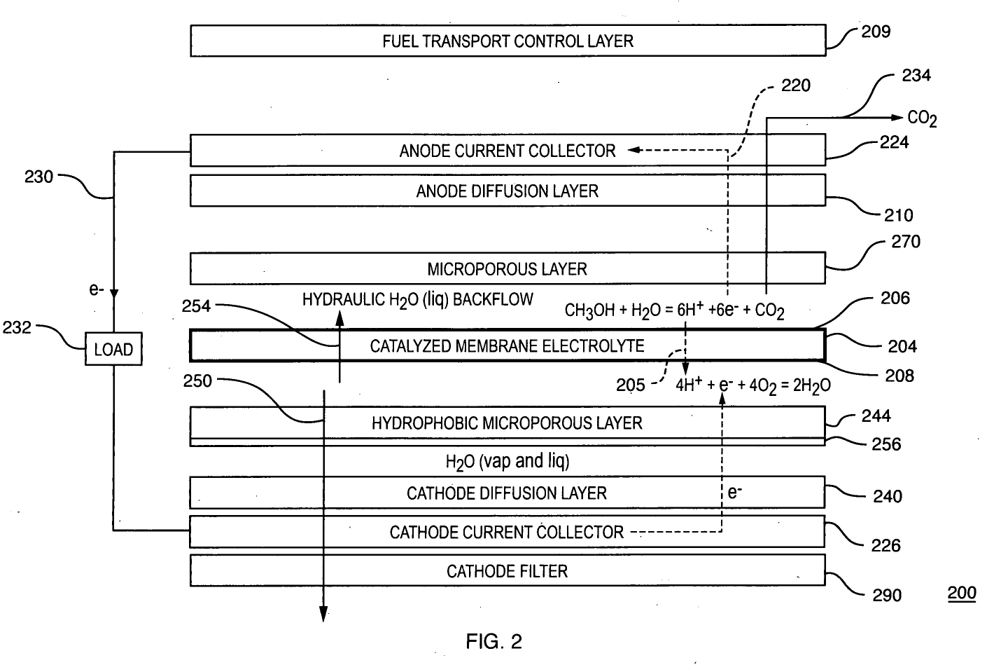

FIG. 2 is a simplified schematic illustration of the unique water management features and structures of the passive system of the present invention. The figure illustrates one embodiment of the direct oxidation fuel cell of the present invention for purposes of description though the invention set forth herein may include a number of other components in addition to those shown while remaining within the scope of the present invention. Many alternative fuel cell architectures are within the scope of the present invention. Further, the illustrative embodiment of the invention is a DMFC with the fuel substance being substantially comprised of neat methanol. It should be understood, however, that it is within the scope of the present invention that other fuels may be used in an appropriate fuel cell. Thus, as used herein, the word fuel shall include methanol and ethanol or combinations thereof and other carbonaceous substances and aqueous solutions thereof, that are amenable for use in direct oxidation fuel cells and fuel cell systems.

The fuel cell 200 includes a catalyzed membrane electrolyte 204, which may be a protonically conductive, electronically non-conductive membrane, sometimes referred to herein as a “PCM”. As noted, one example of the material that may be used for the catalyzed membrane, which is commercially available is Nafion®, a registered trademark of E.I. Dupont de Nemours and Company, a cation exchange membrane based on a polyperflourosulfonic acid in a variety of thicknesses and equivalent weights. The membrane is typically coated on each of its major surfaces with an electrocatalyst such as platinum or a platinum/ruthenium mixture or alloyed particles. Thus, it is referred to herein as the “catalyzed membrane electrolyte.” The catalyzed membrane electrolyte sandwich may be constructed according to any of the various available fabrication techniques, or other fabrication techniques, while still remaining within the scope of the present invention.

One face of the catalyzed membrane electrolyte 204 is the anode face or anode aspect 206. The opposing face of the catalyzed membrane electrolyte 204 is on the cathode side and is herein referred as the cathode face or the cathode aspect 208 of the membrane electrolyte 204. The carbonaceous fuel substance, which in this instance is neat methanol, is introduced through an anode mass transport control layer 209, which is also referred to herein as a passive mass transport barrier, and in one embodiment of the invention, it is a methanol delivery film.

As shown in FIG. 2, the anode reaction is: CH₃OH+H₂O=6H⁺+6e⁻+CO₂. In accordance with this reaction, one molecule of methanol and one molecule of water react at the anode face 206 of the membrane electrolyte 204, the result of which is that 6 protons (6H⁺) cross through the membrane 204. This is made possible by the well-hydrated Nafion® substance of the membrane, which allows the protons to be carried via water across the membrane 204, as illustrated by the dashed arrow, 205. The electrons generated in the process, are conducted as illustrated by the dashed arrow 220 to the anode current collector 224, which is connected via wires 230 and a load 232 to the cathode current collector 226. The carbon dioxide formed in the process (1) at the anode face 206 is (in the embodiment of FIG. 2), vented through the anode diffusion layer 210 out of the fuel cell as illustrated by the arrow 234.

On the cathode side, ambient air is introduced into the cathode portion via a cathode filter (not shown in FIG. 2) and the cathode diffusion layer 240. The cathode diffusion layer is sometimes referred to herein as a “cathode backing layer.” At the cathode aspect 208 of the membrane 204, the reaction is 4H⁺+4e⁻+O₂=2H₂O. Thus, the protons and electrons combine with oxygen from the ambient air at the cathode face 208 to form water (H₂O).

In accordance with the invention, in order to maintain the optimal water distribution between the cell cathode 208 and cell anode 206 as required for optimal cell performance, a number of components can be included in a variety of combinations, as adapted for the particular fuel cell architecture. These water management components include a water management membrane and/or a microporous layer on the cathode side of the cell, a water management membrane and/or a microporous layer on the anode side, and an additional cathode filter layer on the exterior facing side of the cell.

More specifically, as illustrated in FIG. 2, a hydrophobic microporous layer 244 is disposed on the cathode side adjacent to the cathode aspect 208 of the membrane electrolyte 204. This microporous layer 244, which may be based on a hydrophobic material, or treated with a hydrophobic material, acts as a barrier against flow of liquid water produced on the cathode side 208 of the membrane electrolyte 204, in the direction of the arrow 250. The barrier also resists the water that is dragged by protons crossing the membrane 204 so that the liquid water cannot escape out of the cell through microporous layer 244 and, next, the cathode diffusion layer 240.

The microporous layer 244 blocks water in the cathode area and pushes the water which would have passed in the direction of the arrow 250 back across the membrane 204, in the direction of the arrow 254. This is due to a hydrostatic back-pressure created by hydrophobic capillary action of the microporous layer 244. To establish such hydrostatic pressure pushing water back from the cathode into the membrane, the capillary dimensions in the microporous layer have to be sub-micron and the capillary walls, hydrophobic.

Accordingly, as liquid water is generated at cathode aspect 208 of the membrane electrolyte 204, it is blocked by the microporous layer 244 from traveling out of the cell, and the resulting build up of hydrostatic pressure at the cathode causes water to flow through the catalyzed membrane 204 in the direction of the arrow 254 toward the anode, where water is consumed according to Eq. 1.

It is advantageous to have good, uniform adherence between the layers in the catalyzed membrane electrolyte sandwich in order to achieve the desired water management herein. By way of example, and not of limitation, a robust bonding of the microporous layer can be achieved by hot-pressing the microporous layer 244 to the cathode aspect of the membrane electrolyte or the cathode diffusion layer 240. Alternatively, a substantially sustained adherence of the microporous layer 244 to the cathode aspect 208 (which may be the cathode diffusion layer 240) may be achieved by compression across the cell thickness dimension of over 50 PSI. To further assist in causing the water to cross the membrane from the cathode side to the anode side, the catalyzed membrane electrolyte 204 can be chosen to be sufficiently thin, to allow the rate of supply of water from the cathode side to the anode side to be enhanced. In accordance with one embodiment of the invention, the membrane electrolyte 204 is substantially comprised of a product that is commercially available as Nafion 112, sold by E. I. DuPont De Nemours and Company. Alternatives include thin composite membranes that are about 25 microns thick and that are sold by W.L. Gore Company. Use of such thin membranes in DMFCs, facilitating water transport, has not been recognized as possible to date because of the high rate of methanol permeation (“cross-over”) through such membranes in operation of ordinary DMFCs. However, when a controlled fuel delivery layer is used in the DMFC anode, fuel loss across the membrane is practically fully defined by the fuel transport control layer and, consequently, important advantages of thin membranes like Nafion 112 can be safely enjoyed.

In accordance with another aspect of the invention, the microporous layer 244 can be a free-standing water management membrane comprised substantially of expanded PTFE, optionally incorporating embedded carbon microparticles.

The water back-flow achieved by the microporous layer 244 keeps the Nafion® membrane hydrated and provides sufficient water availability to establish the 6 electron anode process and to maintain the local fuel concentration next to the anode surface 206 of the membrane 204 as low as required, This is evidenced by measured high fuel conversion to CO₂ in cells where anode water is provided exclusively by such back flow of water from the cathode across the membrane.

In order to further maintain the required water balance within the cell 200, another microporous layer 270 can be provided on the anode side, contiguous to the anode aspect 206 of the membrane electrolyte 204. This water management membrane, or microporous layer, may be comprised substantially of expanded PTFE, possibly filled with carbon microparticles. This layer 270 maintains water inside the anode aspect. Thus, the two layers together, i.e., the anode side water management layer 270 and the cathode side water management layer 244, effectively confine water between the anode aspect of the catalyzed membrane 206 and the cathode aspect of the catalyzed membrane 208, keeping the Nafion® membrane well hydrated and ensuring that the water content at the anode catalyst is sufficient to maintain the 6 electron process at the anode aspect 206 of the membrane electrolyte. Another requirement for effective push-back of water from the electrode into the membrane, is good adhesion/bonding between layers 244 and 208, and 270 and 206. This is achieved by hot pressing together the stack of layers 240-210, preferably under controlled humidity conditions. Yet another requirement for effective push-back of water from the electrode into the membrane is significant mechanical compression across the thickness dimension of the cell, achieved by proper framing and bolting, or bonding. The compression has to exceed the pressure required to drive a sufficient flux of water through the membrane.

Another aspect of the water management feature of the present invention relates to the fuel cell being an air breathing cell. In an air breathing cell, the cathode side of the fuel cell is open to ambient air, to allow the oxygen into the cathode for the cathode reaction to proceed. The cathode backing, or diffusion layer 240 is usually comprised of a wet-proofed, porous carbon cloth that allows oxygen from the ambient air into the cell.

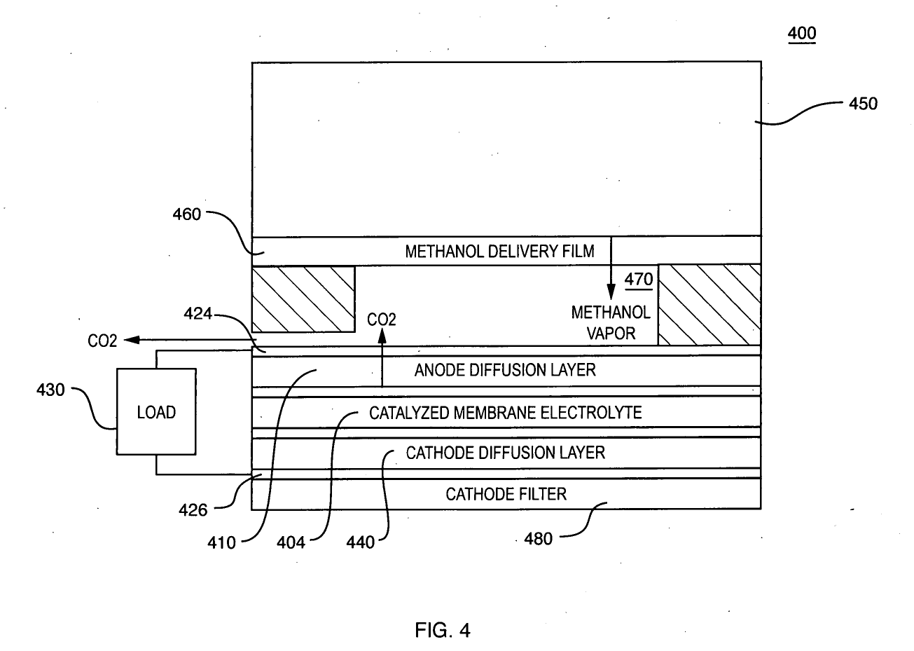

However for cell operation where all the water is internally provided by back flow from the cathode, the porosity of typical cathode backings can result in excessive water evaporation loss. As such, water can be lost from the cathode at a rate determined by vapor transport through the cathode backing in the direction of the arrow 250. Liquid water generated at the cathode catalyst of the catalyzed membrane 204 equilibrates with water vapor at a vapor pressure determined by the inner temperature of the cathode, which is typically 5-10 degrees Celsius above the ambient temperature in an operating cell. The water vapor pressure defines a high side of a water vapor pressure gradient falling across the thickness dimension of the cathode backing layer, with the low side determined by the temperature and relative humidity of the ambient surrounding environment. Thus, a thicker cathode backing or a combination of two or more such layers can help lower the rate of water evaporation from the cell, maintaining sufficient water flow back to the anode. An example is the added layer designated as a cathode filter 290 (referred to hereinafter with reference to FIG. 4), which also serves to filter air impurities. It has also been found by us that a thicker backing layer or multiple backing layers do not degrade cell performance up to some total overall thickness, in that enough oxygen still enters the cathode portion of the fuel cell to maintain the design cell current.

In accordance with one embodiment of the invention, the cathode diffusion layer 240 material is E-Tek DS V2 backing, and the same is used as the additional cathode filter.

Alternatively, instead of multiple backing layers to achieve the thickness required, to limit water vapor escape rate, it may be preferable in certain instances for the convenience of construction, to provide a single porous layer with suitable tortuosity and porosity to achieve the same barrier effect to the water vapor transport rate. In accordance with yet another aspect of the invention, a top layer of expanded PTFE 290 can be added to prevent liquid water from escaping, while still allowing oxygen to enter the cathode area of the fuel cell.

Accordingly, this unique management and control of the liquid water and water vapor of the present invention including pushing water back from the cathode into the membrane 204 by means of hydrophobic microporous layer 244 and curbing the rate of vapor escape through the cathode, achieved using a passive mode of operation, results in water distribution that enables the establishment of the 6 electron anode process and maintenance of the local methanol concentration next to the catalyzed anode surface of the membrane as low as 3% (1M), or below, which is the concentration level for the anode reaction to proceed at minimal methanol loss by cross-over.

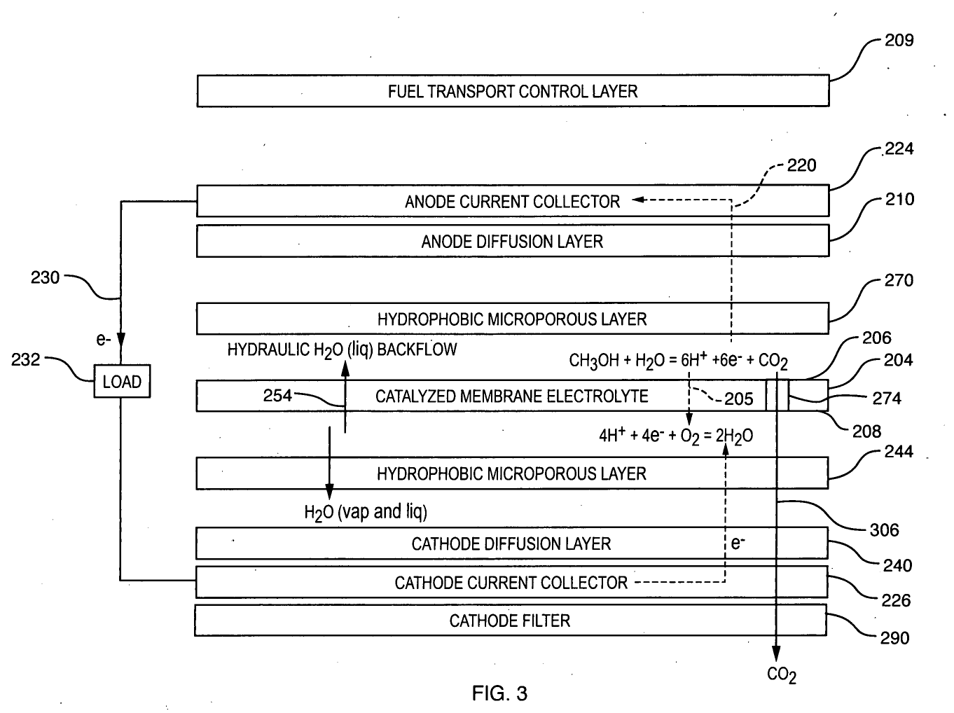

FIG. 3 illustrates another embodiment of the fuel cell of FIG. 2 in which carbon dioxide is vented through the catalyzed membrane electrolyte 204 and out of the cell through the cathode side, as illustrated by the arrow 306. Carbon dioxide management will be discussed further hereinafter.

Fuel Delivery Management and Control

In order to allow the use of neat methanol, which has the advantages outlined above, the rate at which methanol is supplied to the anode must be controlled, preferably by a passive mass transport barrier element disposed between the fuel source and the anode aspect of the catalyzed membrane electrolyte. In one embodiment of the invention, the passive mass transport barrier is disposed in a plane that is generally parallel to the anode aspect of the membrane electrolyte. Preferably, the fuel feed from the fuel source, also referred to herein as the fuel reservoir, is a high concentration fuel, such as neat methanol, having substantially low or zero water content.

A methanol transport barrier element that defines a methanol flux at a level of 10-50% higher than the rate of anodic consumption of methanol should be provided. This flux, predetermined according to the cell current catalytically achievable near the design cell voltage at the relevant cell temperature, can be measured for a given barrier as the limiting current of the cell. This can be accomplished using one of a number of techniques.

Based on the catalytic activity of state-of-the-art DMFC electrodes, the supply rate of methanol should be controlled by such a barrier, such that a limiting current density on the order of 100-200 mA/cm² is achieved at internal cell temperature of 30-40 deg. C. A proper anode transport barrier introduced to allow the use of neat methanol feed with state of the art DMFCs, should allow methanol flux corresponding to this range of current densities. More specifically, the rate of fuel delivery by the passive mass transport barrier of the present invention is a defined rate that is calculated with reference to design cell current. The supply rate of fuel is controlled to correspond to a current density in anodic oxidation of methanol in the range of 100-200 mA/cm², at DMFC operation temperature in the range of 30-40 deg.C. The more exact rate of fuel delivery by the passive mass transport barrier, corresponds to the rate of fuel consumption by the fuel cell, determined by the design cell current, multiplied by a factor of between 1.0 and 1.5. Since at higher cell operation temperatures the cell currents are higher, the supply rate of fuel through the transport barrier will be correspondingly adjusted to higher value, for example by using a thinner barrier layer of similar composition and structure, always conforming to the relationship: Controlled flux through transport barrier=flux consumed at cell anode X (1.0-1.5).

A low porosity layer such as that defined in commonly assigned U.S. Patent Application Ser. No. 10/262,167 filed on Oct. 1, 2002, entitled ANODE DIFFUSION LAYER, can be employed as layer 209 in FIGS. 2 and 3. Such microporous layer includes perforations that are typically pores having a diameter ranging from 0.01μ and 100μ. The perforations deliver and direct the fuel to the catalyzed anode aspect of the membrane at an appropriate rate while substantially resisting carbon dioxide from flowing back into the fuel chamber. This component may also be comprised of a solid porous plug having a pore network that provides for a capillary-force-controlled flow of fuel at the defined rate.

In accordance with the present invention, a methanol vapor delivery film can instead be used for layer 209 in FIGS. 2 and 3, to deliver fuel to the anode aspect at the appropriate rate. Referring now to FIG. 4, a cross section of a fuel cell system 400, in accordance with the present invention, which includes a methanol vapor delivery film is illustrated. The catalyzed membrane electrolyte 404 is sandwiched between an anode diffusion layer 410 and a cathode diffusion layer 440. The current collected is passed through load 430, which is coupled across anode current collector 424 and cathode current collector 426. A fuel reservoir 450, which may be a separate or detachable fuel cartridge, or may be a part of the fuel cell itself, stores a methanol fuel solution, which is preferably 50% methanol or greater, and most preferably neat methanol, for supplying the fuel cell. The methanol delivery film 460 of the present invention is a membrane that is placed as one wall of the fuel reservoir 450.

This methanol delivery film 460 acts as a fuel delivery barrier between the concentrated, or neat methanol source in the fuel reservoir 450 and the membrane electrolyte 404. More specifically, the methanol delivery film 460 limits the rate of the methanol supplied to the anode aspect of the membrane electrolyte 404 presenting a transport barrier while effecting a phase change from liquid methanol in the fuel reservoir 450 to methanol vapor in the vapor chamber 470, shown in FIG. 4. In accordance with one embodiment of the invention, the methanol delivery film is a single layer of a thin polymeric film that is placed between the concentrated, or neat methanol source and anode side of the membrane electrolyte. Addition of another membrane on top of that single layer or surface modification of the single membrane can be also applied to control transport rate and improve transport selectivity (methanol outflow from the reservoir vs. water inflow from the cell). This thin film may be a pervaportion membrane, or other suitable membrane, that effects a phase change from liquid methanol in the fuel reservoir 450 to methanol vapor in the methanol vapor chamber 470.

Another important advantage reached with the use of such a vapor delivery membrane, is the orientation independent seal of methanol liquid in the reservoir and yet another important advantage, is the ability to achieve orientation independent rate of fuel delivery through the vapor delivery membrane. The latter feature can be achieved by coating the inner walls of the reservoir by a thin hydrophilic porous layer, such layer being always in contact along at least one wall with the liquid fuel in the reservoir. Wicking of the fuel along such internal porous coating, ensures continuous coverage of the inner surface of the fuel delivery film by liquid fuel irrespective of orientation, thereby ensuring fuel delivery rate through 460 which is independent of orientation.

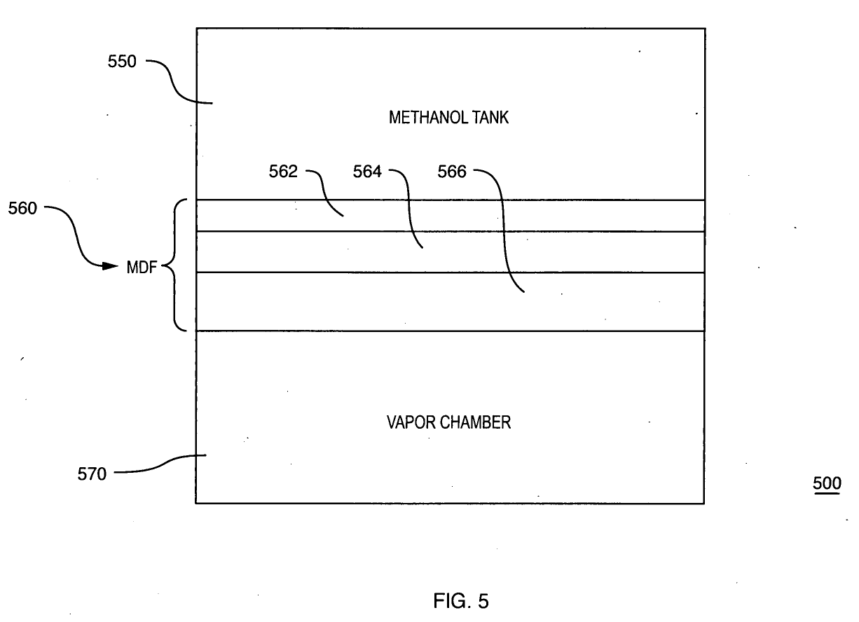

As illustrated in FIG. 5, a gap 570 between the fuel delivery film 560 and the anode aspect of the membrane electrolyte, defines a vapor chamber containing vapor and gas. The vapor gap would contain some liquid as well, but will not be filled with liquid. This gap is also illustrated in FIG. 4 as the vapor chamber 470. FIG. 5 also highlights some details of the fuel delivery film, 560, revealing that this could be a multilayered film. In a case of a pervaporation film, layer 564 could be a non-porous thin film of silicone (e.g., 10-50 micrometer thick), supported on a porous support rendering mechanical stability. The top layer, 566, may be added to modify the surface properties of the silicone film, e.g., to make the surface more hydrophobic.

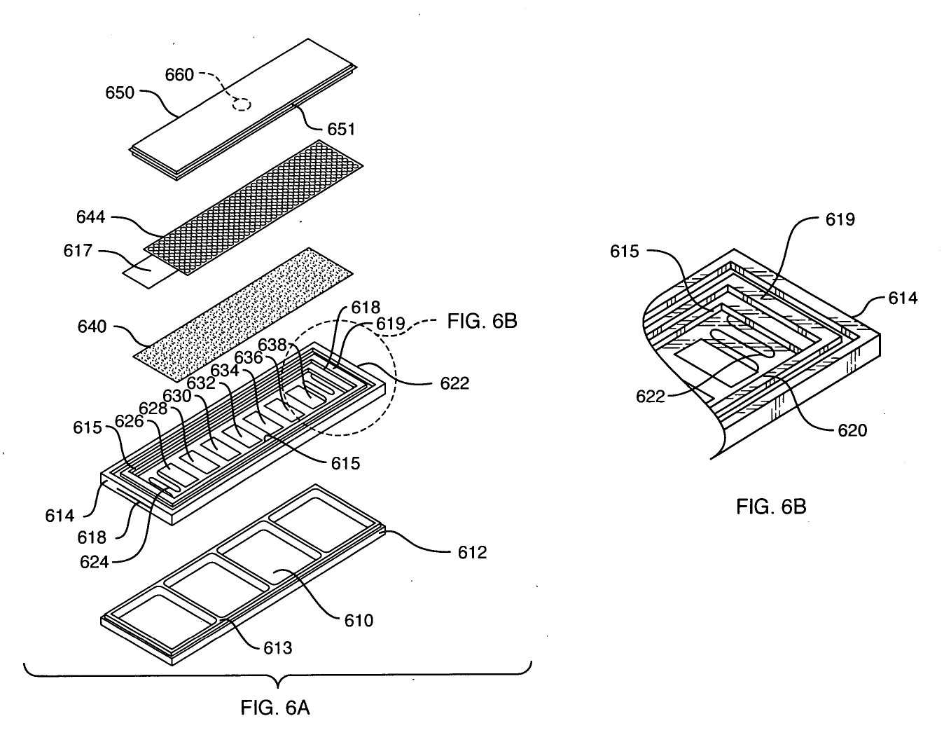

The methanol delivery film can be disposed on a plastic frame, located within a larger system frame in the fuel cell. More specifically, this is depicted in FIG. 6 which is an exploded isometric illustration of the anode portion of one embodiment of the fuel cell system of the present invention. The methanol delivery film 610, which has been described herein with reference to fuel delivery control is sealed onto a methanol delivery film frame 612. The methanol delivery film frame 612 provides physical support to film 610, and the frame 612 has openings or windows therein allowing maximum open surface area of film for the fuel from the fuel tank (not shown) to be vaporized and pass into the vapor chamber. The frame 612 is preferably a plastic substance that does not react substantially with methanol. The methanol delivery film 610 in the frame 612 can be sized to supply one fuel cell, or if several fuel cells are placed side by side, a single sheet of film can be used to supply multiple fuel cells as may be desired in a particular application while remaining within the scope of the present invention. It is also within the scope of the present invention to include additional fuel delivery tools including one or more fuel injectors for spraying fuel onto the anode aspect of the catalyzed membrane electrolyte or into the anode chamber. In accordance with another aspect of the invention, there may be applications in which fuel delivery can be further controlled by heating liquid fuel in the fuel reservoir using catalytic combustion or electric heating for enhanced delivery to the anode chamber.

The methanol delivery film frame 612 has a rectangular rim 613 onto which a system frame 614 is placed to provide structural support to the various components of the system.

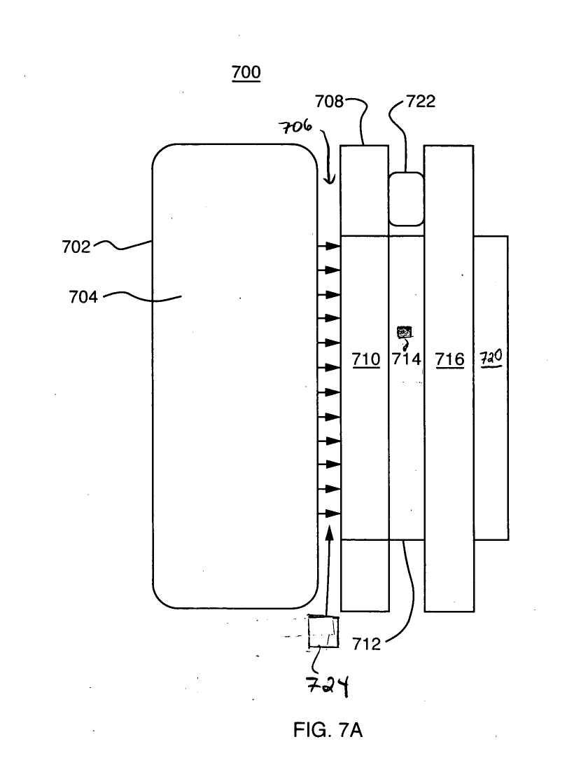

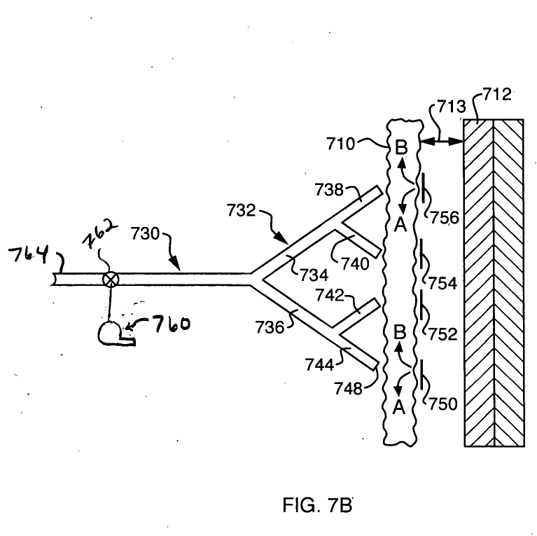

In accordance with another aspect of the invention, the methanol delivery film can be comprised of an evaporation pad which allows for fuel to be delivered to such pad in liquid form from a fuel reservoir that is located remotely from the fuel cell anode. FIG. 7A illustrates a fuel cell system 700 which includes a collapsible fuel tank 702 that contains a highly concentrated or neat methanol fuel 704. A preferred mode of liquid fuel delivery to the evaporation pad, would be pumping, in which case controlled adjustment and metering of the rate of fuel delivery become possible. Such controlled adjustment of the rate of liquid fuel delivery is an important key for achieving high fuel utilization in this mode of operation. Although the fuel tank is illustrated in a side by side relationship with respect to the fuel cell components in FIG. 7A, it should be understood that the fuel reservoir 702 (which may be a collapsible fuel tank) can be located in one or more available spaces within the electronic device which is being powered by the fuel cell system of the present invention.

The liquid fuel from the fuel tank 702 is delivered through one or more conduits which are schematically illustrated by the arrows generally designated by reference character 706. The liquid fuel delivery may involve a single conduit with one injection point or it may be one or more conduits coupled to a “flow splitter” which can direct one liquid source into multiple parallel liquid delivery points. The liquid fuel is delivered through the injection points 706 to a thin fuel distribution frame 708 which houses an evaporation pad 710. The evaporation pad 710 is readily wetted by the fuel and may be substantially comprised of a microporous material from which evaporation of the liquid fuel can take place. An anode backing 712 serves as a diffusion and current collection layer.

Carbon dioxide ventilation channels, such as the channel 714, may be embedded into or placed in the vapor gap preferably in close proximity to the anode backing 712. The polymer electrolyte membrane 716 contains an anode catalyst layer facing the anode backing 712, and a cathode catalyst layer facing the cathode backing 720. Gasketing, such as that shown as designated by reference character 722, may be utilized. The gasketing 722 can also be designed to include carbon dioxide ventilation channels. It is also noted that either the anode backing 712, or the fuel distribution frame 708, can be made to function as an anode current collector. The same is true for the cathode backing 720 which can be constructed and coupled in the fuel cell in such a manner as to function additionally as a cathode current collector.

FIG. 7B is an enlarged view of one portion of the fuel cell system of FIG. 7A, located near an injection point. The same components as those illustrated in FIG. 7A have the same reference characters in FIG. 7B. The evaporation pad 710 is disposed generally parallel to the anode diffusion layer 712, also referred to as the anode backing 712. A vapor gap 713 exists between the evaporation pad 710 and the anode diffusion layer 712. A conduit 730 from a fuel source (not shown in FIG. 7B) has at one end thereof a flow splitter 732. Liquid fuel is delivered at a controlled rate from the fuel source via the conduit and the flow splitter 732. The flow splitter 732 is a network of tubes that divides the liquid flow from the single conduit 730 into individual branching tubes 734-744. Each set of branches such as the first set 734, 736 may have a smaller diameter than the previous set. Of the smallest diameters will typically be the end branches 738-744, which include the injection ports, such as the injection port 748 which is at the end of the tube branch 744. The end branches 738-744 are arranged to provide parallel feed streams. By using a parallel network of tubes of a sufficiently small diameter, relatively high linear flow of methanol within each narrow tube is achieved at some given overall fuel feed rate demand by the anode. The linear liquid flow rate could then be made much greater than the linear rate of water diffusing back into the feed tube from any liquid water which may collect in the evaporation pad 710 during cell operation. This effectively prevents diffusion of water generated at the cell electrode back to the fuel reservoir, which back diffusion, if left unchecked, could result in dilution of the highly concentrated fuel, causing feed of fuel of variable concentration.

In accordance with another aspect of the invention, the conduit 730 has a splitter 732 which divides the tube into 64 small tube endings that are the injection ports, each having a diameter of about 0.10 mm (millimeters). The design of the endings (748) of the tubes (744) carrying injection port(s) on their tip(s) should be such that these tube endings (748) are narrow enough to have substantially all methanol filling them fully swept out (e.g., by a pump) under ordinary fuel delivery rates, before any significant amount of water has an opportunity to penetrate the tube by diffusion up the tube from the evaporation pad 710.

This is an important feature of the design of liquid fuel feed through a tube network from the reservoir to the anode, without which there could be back migration of water up the supply tubes 738-744 from the evaporation pad 710 (where it is likely to collect during fuel cell operation). This could bring about continuous dilution of methanol all the way to the pump outlet. Such dilution could, at the least, upset the correlation between metered volume pumped and the actual mass of methanol delivered to the anode.

To arrive at an optimal desired injection port diameter and flow rate of methanol in order to avoid disadvantages caused by water back diffusion, the following calculations are provided in accordance with the invention. It should be understood by those skilled in the art that the calculations are provided for purposes of illustration and complete description, but it is expressly contemplated that the invention is not limited in scope to encompass only those circumstances described in the equations.

More specifically, calculation of the requirement on a microtube diameter to substantially eliminate the effect of water diffusion into the microtube as methanol flow is driven through the tube into a pad containing water, is as follows:

Assume:

(1) Methanol flows at overall controlled rate of F cc/hour (cubic centimeters per hour) into an anode evaporation pad, as described herein; and
(2) The overall flow is divided by a splitter into n microtubes each of cross-sectional area A and length L in direct injection contact with the evaporation pad.

The linear rate of an advancing front of liquid fuel in each microtube will be: F/nA and consequently the time to cross the length L will be: L/{F/nA}. The typical time for a liquid a to diffuse a distance L into liquid b, is given as: (L)²/D, where D=2×10⁻⁵ cm²/sec (for water diffusion into methanol), and the requirement for the linear diffusion to be much slower than the rate of linear liquid flow, is, consequently:
(L)²/D>>L/{F/nA}
Hence, the condition for the cross-sectional area of each microtube to be small enough to practically eliminate counter diffusion of water, is:
A<<LF/nD

Typically, the feed tube or flow splitter end tube design is such that the ratio of cross sectional area of the tube to it's length (A/L), is significantly smaller than the ratio of the designed fuel flow in the end tube to the diffusion coefficient of water in the fuel ((F/n)/D). Though not limiting to the invention, (A/L) is at least five times less than ((F/n)/D).

By way of example, if the methanol feed flow demand is F=0.3 cc/hour, and as noted the water diffusion into methanol is D=2×10⁻⁵ cm²/sec, and the length of each of the last branches of flow splitter is L=1 cm. Then, using a splitter of n=64 (determined by a 6 step binary splitter), this yields a condition of:
A<<0.01 cm², or: tube diameter<<1 mm

From the above example, it will be appreciated by those skilled in the art that supplying methanol at 0.3 cc/hour through a network of 1 cm long microtubes of a diameter much (e.g., 10 times) smaller than 1 mm, will make the extent of diffusion of water against the driven flow of methanol practically zero. Accordingly, selecting a parallel array of microtubes of the diameter calculated as just described for direct liquid injection into the evaporation pad, will avoid the disadvantages outlined herein regarding potential dilution of methanol fuel concentration, which could, at the least, upset the correlation between the metered volume pumped and the actual mass of methanol delivered to the anode.

Returning to FIG. 7B, across from each injection port such as injection port 748, a liquid dispersion member 750 is placed over the evaporation pad, which is particularly advantageous when the number of injection ports per unit anode area is limited and the vapor gap width minimal. This liquid dispersion member 750 may be substantially comprised of a single, or patterned baffle, made of tape or foil material impermeable to fuel in either liquid or vapor form, that acts to facilitate lateral distribution of fuel entering the pad through discrete injection points. This member 750 corrects for a tendency of localized high fuel vapor flux centered directly over the injection point 748, and encourages spreading of the injected fuel across the pad 710 in the direction of arrows A and B.

Separate liquid dispersion members 752, 754 and 756 may be located across from each injection port or a single member may be used, as desired in a particular application of the invention. The fuel subsequently vaporizes from the pad uniformly across the surface and travels across the vapor gap 713 to the anode surface, through the anode diffusion layer 712.

In accordance with one aspect of the invention, the evaporation pad 710 can be substantially comprised of a microporous material placed on the surface of the anode compartment facing the fuel injection port 748, for example. The micro-porous fabric material will help distribute the fuel across the surface of 710. The evaporation pad can be made of various woven or non-woven polymeric, or inorganic materials, in single or multi-layer form. In most applications of the invention, it will be preferable to use a pump (micro-pump) to drive the fuel to the injection port(s), enabling control of the rate of fuel delivery through the operation of such pump.

It should be understood by those skilled in the art that an adjustable, controlled fuel delivery rate is highly important for implementation of effective system control in systems based on DMFCs operating with 100% fuel feed. The controlled fuel delivery rate enables simultaneous adjustment of the cell temperature and the cell water content, thereby allowing optimization of both temperature and water content and, consequently, maximize cell performance.

A micro-pump 760 is provided in accordance with one aspect of the invention, and it can be associated with the valve 762 as shown schematically in FIG. 7B, or the micro-pump 760 can be arranged in the system such that it also provides a valving function when turned off, thereby providing effective system turn off function. However, it is expressly noted herein that the fuel need not be so pumped. In the pump free design, a pressure differential between the fuel source and the anode area generated by a pressurized cartridge or other means could successfully provide for adequate liquid fuel delivery to the evaporation pad in this type of fuel cell system. The valve 762 can be disposed between the network of tubing at the end of the conduit 730, and the upstream portion 764 of the conduit that leads to the fuel reservoir. This provides separation between the reservoir (702, FIG. 7A) and the conduit 730 (FIG. 7B) when fuel is not being delivered to the fuel cell.

A simple metering pump/valve/actuator 724 (shown schematically in FIG. 7A), can be used to feed the liquid fuel into the anode chamber. The metering pump/valve actuator device 724 allows for essentially complete control of the liquid methanol feed rate to the cell, and it can be constantly readjusted based on a reading of a cell characteristic, for example, cell temperature, to optimize cell performance. The metering pump/valve/actuator device 724 can also be turned off which could provide for a complete “OFF” position for both fuel and fuel cell even without a valve.

It should be understood from this embodiment of the invention, that it allows the liquid fuel feed rate to be easily regulated and controlled upstream the fuel cell. In practicing vapor feed within the anode, feeding neat liquid fuel from reservoir to cell in the form of metered liquid flow and using a network of tubes, has important advantages, as will be appreciated by those skilled in the art, over approaches based on wicking of liquid fuel all the way from the fuel reservoir to anode. In the latter case, achieving effective fuel feed rate control is much more difficult, if not impossible. Also, the point of liquid methanol feed into the anode can be well separated from the location of the fuel tank, the fuel tank consequently locatable in any convenient available space within the device being powered by the fuel cell rather than being forced to maintain close physical contact with the fuel cell.

Within the anode, liquid fuel-to-vapor fuel transition occurs at the required rate of supply to the anode, as controlled by the metered rate of fuel delivery into the anode and the inner anode temperature. By application of thinner membrane electrolyte membranes of a thickness lower than about 100 micrometers and of cathode microporous layers of high liquid water blocking capacity, neat (100%) liquid methanol can be pumped directly to the cell to be internally evaporated, as taught earlier in commonly assigned U.S. patent application Ser. No. 10/413,983, by Ren et al., the parent application of the present application, filed on Apr. 15, 2003, which was incorporated by reference herein, as well as commonly assigned U.S. patent application Ser. No. 10/454,211, by Ren et al. for PASSIVE WATER MANAGEMENT TECHNIQUES IN DIRECT METHANOL FUEL CELLS, filed on Jun. 4, 2003, and which is also incorporated by reference herein.

The present invention has further advantages in that being based on pumping, or pressure differential driven liquid flow, the fuel feed of the present invention from the reservoir to the cell is orientation independent, as is the fuel delivery within the cell because the fuel vaporizes on entering the vapor chamber and vapor flow to the anode is not orientation dependent.

Carbon Dioxide Management

Another substance that must be managed in order to produce optimum direct methanol fuel cell performance is carbon dioxide produced in the anode reaction. In prior art designs, the gaseous carbon dioxide produced in the electricity-generating reaction at the anode typically travels away from the catalyzed surface of the membrane through the anode diffusion layer and ultimately into the anode chamber that contains the fuel supply. This can interfere with liquid fuel access to the anode aspect of the membrane.

Thus, it is preferred to direct the anodically-generated carbon dioxide out of the anode chamber prior to its entering the anode compartment. In U.S. patent application Ser. No. 10/262,167 referenced herein, an anode diffusion layer is described that includes conduits or channels on the surface adjacent the anode catalyst, that provide preferential flow paths for carbon dioxide to be laterally directed away from the catalyzed membrane and out the side wall of the anode chamber, such that it does not travel out through the diffusion layer into the anode chamber of the fuel cell.

Several other techniques for removing carbon dioxide are provided here. The first is best understood with reference to FIGS. 6 and 7. By way of background, carbon dioxide that is generated at the anode side of the membrane electrode assembly 650 may collect in the methanol vapor chamber leading to a buildup of CO₂ pressure that can potentially impede cell performance. In accordance with the invention, at least one gas exit port is provided in the anode chamber. Gaseous anode products are released directly to the ambient environment through gas exit ports, and the gas exit ports are preferably located in close proximity to the anode aspect of the catalyzed membrane. In the illustrative embodiment, the gas exit port is in the form of a CO₂ router device 620 (FIG. 6) that includes two CO₂ escape vents 622 and 624, router device 620 SG: I could not find 620 in FIG. 6. is placed within the anode portion of the fuel cell. The router device 620 directs carbon dioxide across the windows 626 through-638, and into the CO₂ escape vents 622 and 624 which can be straight channels, serpentine channels, or can take other configurations as desired in a particular application.

The CO₂ router device 620 is held by the system frame 614. In accordance with the embodiment illustrated in FIGS. 6 and 7, the system frame 614 has a series of flanges into which the components of the cell fit securely and are thereby held in place. For example, the CO₂ router 620 rests on a flange in the recess 615 in the frame. Next, an EPTFE water management membrane 640 is placed directly on top of the router 620.

The next component, the anode current collector 644 has a notch 617, which fits in the slot 618, and the current collector 644 rests on the flange 618 in the system frame 614. A raised platform 619 provides support for the MEA 650 and defines a vapor chamber for the flow of fuel to the anode diffusion layer, and, ultimately to the anode aspect 651 of the catalyzed membrane.

The CO₂ router device 620 is shown in greater detail in FIG. 7, which is an enlarged section of the carbon dioxide router 620, and the system frame 614 that supports it. The escape route 620 may be of a serpentine shape, as illustrated, or may be a straight channel. And, the router may include multiple channels along its periphery in addition to the two shown while remaining within the scope of the present invention.

The inventive CO₂ escape router device 620 manages carbon dioxide by directing it out of the cell via the channel leading to the surrounding atmosphere. This results in effective removal of carbon dioxide, but at the same time, no significant methanol loss or emission is allowed through the carbon dioxide escape routes. In accordance with another aspect of the invention, one or more pin holes in the catalyzed membrane electrolyte can allow for carbon dioxide to escape through the membrane into the cathode side, and then to travel out through the cathode filter. A pinhole 660 is illustrated in phantom in FIG. 6.

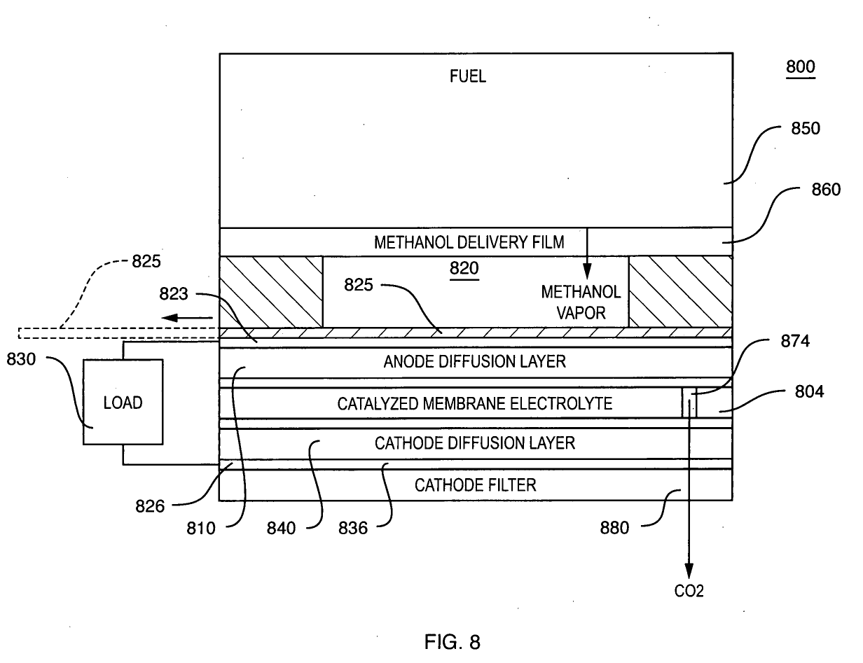

Another method of managing carbon dioxide was described in commonly-owned United States Patent Application Publication No. 2002/0102451 A1 for a FUEL CELL MEMBRANE AND FUEL CELL SYSTEM WITH INTEGRATED GAS SEPARATION, which is incorporated by reference herein. In accordance that description, carbon dioxide can be directed through conduits across the thickness of the membrane electrolyte itself For convenience of reference, this feature is illustrated in FIG. 8.

The direct oxidation fuel cell 800 of FIG. 8 includes catalyzed membrane electrolyte 804 and anode diffusion layer 810 and cathode diffusion layer 840. Current collector plates 823 and 826 are connected by a load 830 for collecting the electricity generated by the cell. Fuel, of preferably 50% methanol or greater, is contained in the fuel reservoir 850 and it passes through methanol delivery film 860 in the manner hereinbefore described and undergoes a phase change to the form of methanol vapor and is contained in methanol vapor chamber 820 from which chamber it is supplied to the anode. This methanol vapor is presented to the anode aspect of the catalyzed membrane electrolyte to produce the electricity of the reaction.

In certain applications, it may be desirable to provide an adjustable shutter 825 in the fuel cell, which can be opened as shown in phantom in FIG. 8, to allow fuel to be delivered at variable, controlled rates through the methanol delivery film 860. The adjustable shutter 825 may be also completely closed, as shown in solid lines in FIG. 8, to block the flow of vaporous fuel from the methanol delivery film 860, and thus preventing fuel from travelling to the anode diffusion layer and ultimately to the anode aspect of the catalyzed membrane electrolyte. This is described in further detail in a commonly-assigned U.S. patent application Ser. No. 10/413,986, of Hirsch et al, entitled VAPOR FEED FUEL CELL SYSTEM WITH CONTROLLABLE FUEL DELIVERY,” which was filed on Apr. 15, 2003, and which is incorporated by reference herein.

The carbon dioxide produced in the anodic reaction travels through a carbon dioxide channel 874, then passes through the cathode diffusion layer 840 and exists through the cathode filter 880 without interfering with the anodic reaction.

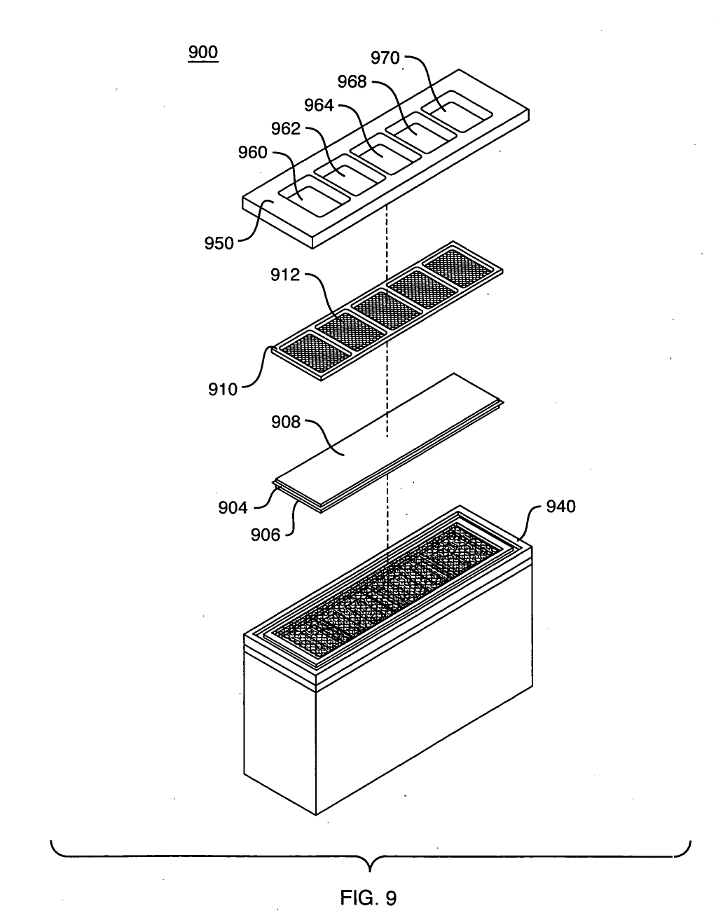

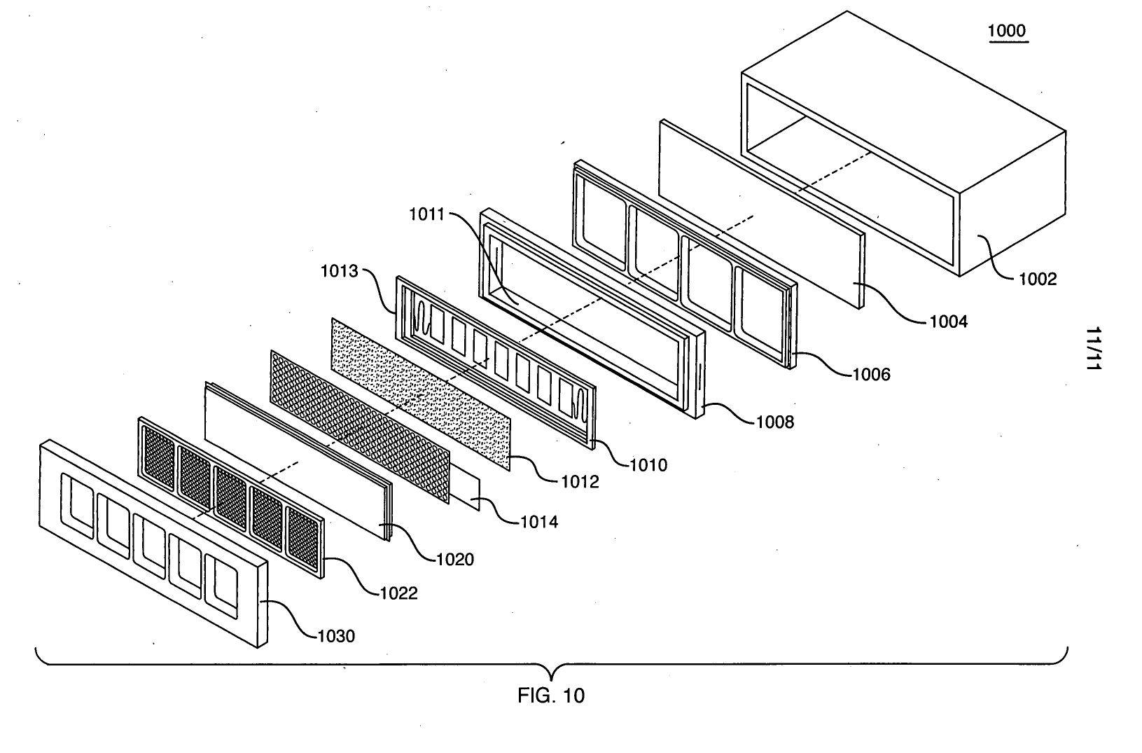

To further complete the description of the fuel cell system of the present invention, an exploded illustration from a cathode perspective is provided in FIG. 9. The fuel cell system 900 includes the MEA assembly 904, which has an anode side 906 and a cathode side 908. The MEA comprises the catalyzed membrane electrolyte and the anode and cathode diffusion layers described herein with respect to the other figures.

Sandwiched next to the cathode side 908 of the MEA 904 is a cathode compression frame 910. Welded to the cathode compression frame in the embodiment illustrated in FIG. 9 is the cathode current collector, which is a highly conductive wire mesh with low resistance.

The cathode current collector 912 may be, in other applications, a separate component not necessarily welded to the cathode compression frame 910. The cathode compression frame is pressed down onto the MEA assembly, which in turn, sits in the system frame 940. The cathode compression frame provides and maintains good contact between the various components of the MEA and ensures structural integrity.

This frame also contributes to the maintenance of hydrostatic pressure that pushes liquid water from the cathode backing through the membrane electrolyte to the anode in the manner described with respect to FIG. 2. A cell assembly top plate 950 is then used to compressively maintain the components within the fuel cell. As can be seen from FIG. 9, the cell assembly top plate 50 has openings 960-970. This allows the cell to be an air breathing cell. Oxygen from the ambient air will diffuse through these openings through the cathode compression frame 910 and to the cathode side 908 of the MEA assembly 904, supplying the cathode half reaction needed for operation of the fuel cell. The cathode filter (not shown in FIG. 9), illustrated as 880 in FIG. 8 limits cathode water evaporation rate and resists any impurities in the ambient air from entering into the cell, but allows sufficient oxygen to enter the cell and further allows carbon dioxide to exit the cell in the embodiment of FIG. 9.

In operation, the fuel cell system of the present invention will be described with reference to the exploded system assembly illustration of FIG. 10. The system includes a neat methanol (or other fuel substance) to be provided in fuel tank assembly 1002. This fuel undergoes a phase change when it passes through the methanol delivery film 1004.

It is noted that a single methanol delivery film component 1004 may be placed across an array of suitably connected fuel cell in accordance with the present invention. In such a case, the fuel cell array could be fastened together and compresses under the frame 1006.

Alternatively, a plurality of fuel cells in accordance with the present invention can be arranged in a bipolar fuel cell stack, in a manner that will be understood by those skilled in the art.

Whether in a single fuel cell, an array of fuel cells, or in a fuel cell stack, the methanol vapor enters a vapor chamber, which is defined between the methanol delivery film 1004 and the anode current collector 1014. The methanol delivery film is designed to generate a methanol vapor flux into the vapor chamber required to reach the maximum cell current achievable from the MEA at the design temperatures multiplied by a factor of 1.0 to 2.0. The methanol vapor passes through an optional ePTFE water management membrane 1012, the anode current collector 1014 and the anode diffusion layer. The anode reaction, proceeds to produce carbon dioxide, 6 protons and 6 electrons. The carbon dioxide in the embodiment shown in FIG. 10 travels back through the anode current collector 1014 to the CO₂ router device 1010, and the CO₂ is directed through the openings of the router and travels through the serpentine paths 1011 and 1013 and out of the fuel cell system assembly. The protons cross the protonically-conductive membrane of the MEA assembly 1020 and this is aided by the water supplied by back pressure provided by the microporous layer at the cathode assisted in turn by the compression across the cell, such re-routing of the water from the cathode into the membrane maintaining the Nafion® membrane in a well-hydrated state. The electrons produced in the anodic reaction are collected in the anode current collector 1014, which is connected across a load (not shown) to the cathode current collector 1022.

The cathode current collector 1022 is in the embodiment of FIG. 10 combined with compression frame assembly. The compression frame assembly, as noted with respect to FIG. 9, maintains the cathode components under pressure in order to keep water produced in the cathodic reaction within the cell and provide it for the anode process, as described herein. The cell assembly top plate 1030 holds all of the components in the appropriate position in the system frame 1008 that is fastened to the fuel tank assembly 1002. Thus, water, produced at the cathode, is maintained within the catalyzed membrane to create the appropriate hydration for the Nafion® membrane and to keep water available for the anodic reaction.

This, in combination with the control of the rate of methanol delivery by the methanol delivery film allows the use of neat methanol in the fuel tank as the fuel source. Thus, the hitherto assumed need of water in a direct methanol fuel cell system to be either carried, or collected and pumped externally from cathode back to anode, is eliminated. The system herein described was shown by us to exhibit utilization of 80% of neat methanol fuel stored in the fuel tank based on the electric charge expected in the complete oxidation, 6 electron process set forth in equation (1), while maintaining a power density in the range of 20-30 mW per cm² of PCM area in a cell operating neat 35 deg. C. Accordingly, a highly efficient microfuel cell has been reduced to practice, that has a reduced size and volume due to the elimination of the need to either carry water or return it from cathode by external pumping and neither air blowing is required to achieve the above mentioned performance.

The foregoing description has been directed to specific embodiments of the invention. It will be apparent, however, that other variations and modifications may be made to the described embodiments with the attainment of some or all of the advantages of such. Therefore, it is the object of the appended claims to cover all such variations and modifications as come within the true spirit and scope of the invention.

1. A method of delivering fuel to a fuel cell anode, including the steps of:
(A) providing a direct oxidation fuel cell having a catalyzed membrane electrolyte with an anode aspect and a cathode aspect, and anode and cathode diffusion layers located adjacent to the anode aspect and the cathode aspect, respectively;
(B) delivering neat, or highly concentrated liquid fuel from an associated reservoir to said fuel cell with the liquid fuel flow driven by means allowing adjustment and control of the liquid fuel delivery rate;
(C) injecting the liquid fuel into an evaporation pad that is disposed generally parallel to said anode diffusion layer, with a vapor gap disposed there between; and
(D) providing an exit port in the anode chamber to enable release of CO₂ gaseous product but no liquid release.

2. The method as defined in claim 1, including the further step of providing a liquid flow splitter introduced between a liquid fuel reservoir exit tube and said evaporation pad, to achieve multi injection points from a multiplicity of narrow tubes distributed across the cross-sectional area of the anode, into the evaporation pad.

3. The method as defined in claim 1, including the further step of providing a micro-pump defining a rate of liquid fuel delivery to the evaporation pad, and using micro-pump operational parameters to serve as basis for metering such rate as well as metering the overall fuel consumption from the reservoir over a given period of time.

4. The method as defined in claim 1 including the further step of:
providing a single or patterned baffle on said evaporation pad on the side of the pad that faces the anode diffusion layer and generally across from the location at which the fuel is delivered into said evaporation pad, such that liquid fuel dispersion across said evaporation pad is facilitated, whereby said liquid fuel evaporates evenly across said vapor gap to be provided substantially uniformly to the major aspect of the anode through the anode diffusion layer.

5. The method as defined in claim 1 including the further step of:
selecting fuel cell components so as to achieve sufficient spontaneous water flow from the cathode to the anode within the cell, to allow cell operation with neat methanol supply to the anode and no external water pumping, such components including hydrophobic cathode microporous layers and polymeric membranes of thickness lower than 100 micrometers.

6. The method as defined in claim 2 including the further step of:
selecting fuel cell components so as to achieve sufficient spontaneous water flow from the cathode to the anode within the cell, to allow cell operation with neat methanol supply to the anode and no external water pumping, such components including hydrophobic cathode microporous layers and polymeric membranes of a thickness lower than 100 micrometers.

7. The method as defined in claim 3 including the further step of:
selecting fuel cell components so as to achieve sufficient spontaneous water flow from the cathode to the anode within the cell, to allow cell operation with neat methanol supply to the anode and no external water pumping, such components including hydrophobic cathode microporous layers and polymeric membranes of a thickness lower than 100 micrometers.

8. The method as defined in claim 1 including the further step of:
injecting the liquid fuel through an injection port or array of injection ports at the end of tubes which are narrow enough to have substantially all of the liquid fuel filling the tube endings fully swept out towards the evaporation pad under ordinary fuel delivery rates, before any significant amount of water penetrates the tube by diffusion up the tube from said evaporation pad.

9. The method as defined in claim 1 including the further step of:
controlling and metering the rate of liquid fuel delivery while retaining a capability of turning off partially or completely the liquid fuel supply.

10. The method as defined in claim 1 including the further step of:
selecting a microtube for delivery of fuel to said evaporation pad, said microtube being of such a diameter that back diffusion of water against driven flow of fuel is substantially zero.

11. A direct oxidation fuel cell system, comprising:
(A) a direct oxidation fuel cell having a catalyzed membrane electrolyte with an anode aspect and a cathode aspect, and anode and cathode diffusion layers located adjacent to the anode aspect and the cathode aspect, respectively;
(B) a fuel reservoir containing at least one source of neat or highly concentrated fuel; and
(C) a conduit disposed in fluid communication with said fuel reservoir and said conduit delivers liquid fuel through the cell wall into said evaporation pad at an adjustable, controlled rate and the liquid fuel, when it reaches said evaporation pad, vaporizes into a substantially vaporous fuel which is provided to the anode.

12. The direct oxidation fuel cell system as defined in claim 11, wherein a single or patterned baffle is placed on said evaporation pad on the side of the pad that faces the anode diffusion layer and generally across from the location at which the fuel is delivered into said evaporation pad, such that liquid fuel is dispersed across said evaporation pad and consequently evaporates substantially evenly across said vapor gap to thereby be provided substantially uniformly to the major aspect of the anode through the anode diffusion layer.

13. The direct oxidation fuel cell system as in claim 11, wherein fuel cell components are chosen to achieve sufficient spontaneous water flow from the cathode to the anode within the cell, to allow cell operation with neat methanol supply to the anode and no external water pumping, such components including hydrophobic cathode microporous layers and polymeric membranes of thicknesses lower than about 100 micrometers.

14. The direct oxidation fuel cell system as defined in claim 11 wherein said conduit terminates in a single injection port.

15. The direct oxidation fuel cell system as defined in claim 11 wherein said conduit passes liquid fuel into a flow splitter which divides the fuel flow into multiple liquid injection ports.

16. The direct oxidation fuel cell system as defined in claim 11 having the conduit terminating at the cell in the form of multiple liquid feed tubes and multiple injection points.

17. The direct oxidation fuel cell system as defined in claim 11 further comprising a baffle member placed over the evaporation pad.

18. The direct oxidation fuel cell system as defined in claim 11 wherein said fuel reservoir is located remotely from said fuel cell and said conduit connects the fuel reservoir to the fuel cell.

19. The direct oxidation fuel cell system as defined in claim 18 wherein a valve is disposed between a portion of said conduit that leads to said fuel reservoir and a portion of said conduit that connects to the fuel cell.

20. The direct oxidation fuel cell system as defined in claim 11 wherein said conduit has at least one microtube ending for delivering fuel, said microtube(s) ending(s) having a diameter that is small enough such that back diffusion of water against driven flow of fuel is substantially zero.

21. The direct oxidation fuel cell system as defined in claim 11 wherein said fuel is neat methanol.

22. The method as defined in claim 1 further comprising the step of:
achieving a higher rate of fuel vaporization by employing heat created by fuel cell operation.

23. The method as defined in claim 1 further comprising the step of
evaporating excess water from said cathode aspect by employing heat created by fuel cell operation.

24. The method as defined in claim 1 including the further step of providing a feed tube or flow splitter end tube design, where the ratio of cross sectional area of the tube to it's length (A/L), is significantly smaller than the ratio of the designed fuel flow in the end tube to the diffusion coefficient of water in the fuel ((F/n)/D).

25. The method as defined in claim 24 wherein (A/L) is at least five times less than ((F/n)/D).
